(19) United States
(12) Patent Application Publication
(10) Pub. No.: US 2009/0160733 A1
(43) Pub. Date: Jun. 25, 2009

(54) INFORMATION PROCESSING DEVICE AND DISPLAY CONTROL METHOD

(75) Inventor: Hiroaki Chiba, Sagamihara-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/248,794

(22) Filed: Oct. 9, 2008

(30) Foreign Application Priority Data
Dec. 21, 2007 (JP) 2007-331055

(51) Int. Cl. G09G 5/00; H04N 5/64

(52) U.S. Cl. 345/1.3; 348/836; 348/E05.128

(57) ABSTRACT

According to one embodiment, an information processing apparatus includes a cabinet, a first display section connected to the cabinet, a first display control section, integrated in the cabinet, which executes display control of the first display section, a second display control section, integrated in the cabinet, which executes display control of a second display section which can be connected to the cabinet, an identifying section which identifies connection of the second display section, and an output section which, when it is judged by the identifying section that the second display section is connected to the cabinet, stops the output of signals from the first display control section, and outputs signals to the second display from the second display control section.

### CROSS-REFERENCE TO RELATED APPLICATIONS

This application is based upon and claims the benefit of priority from Japanese Patent Application No. 2007-331055, filed Dec. 21, 2007, the entire contents of which are incorporated herein by reference.

### BACKGROUND

1. Field

One embodiment of the present invention relates to a display control method generally, and more specifically to an information processing apparatus and display control method which can automatically switch connection when an external display is connected.

2. Description of the Related Art

In general, some personal computer products include an integrated GPU in chip sets. These personal computers with the integrated GPU in their chip sets are, in some cases, further equipped with a GPU board in order to support the case where a high-resolution external monitor is connected. For example, Jpn. Pat. Appln. KOKAI Publication No. 2007-179225 discloses a technique of switching over between a GPU built in the chip set and a GPU board externally connected to the computer by operation of a user. (See Jpn. Pat. Appln. KOKAI Publication No. 2007-179225.)

However, the technique disclosed in Jpn. Pat. Appln. KOKAI Publication No. 2007-179225 entails the following drawbacks. That is, the switching between the GPU built in the chip set and the GPU board externally connected to the computer must be operated manually by the user. Further, each time the switching is carried out, the system must be rebooted.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram schematically showing an example of the structure of a data processing apparatus according to an embodiment;

FIG. 2 is an exemplary block diagram showing the structure of the data processing apparatus according to the embodiment;

FIG. 3 is an exemplary conceptual diagram showing which GPU is connected which respective monitor in the data processing apparatus according to the embodiment;

FIG. 4 is an exemplary flowchart illustrating a display control method to which the data processing apparatus according to the embodiment is applied;

FIG. 5 is an exemplary flowchart illustrating a display control method to which the data processing apparatus according to the embodiment is applied; and

FIG. 6 is an exemplary flowchart illustrating a display control method to which the data processing apparatus according to the embodiment is applied.

### DETAILED DESCRIPTION

Various embodiments according to the invention will be described hereinafter with reference to the accompanying drawings. In general, according to one embodiment of the invention, an information processing apparatus includes: a cabinet; a first display section connected to the cabinet; a first display control section, integrated in the cabinet; which executes display control of the first display section; a second display control section, integrated in the cabinet; which executes display control of a second display section which can be connected to the cabinet; an identifying section which identifies connection of the second display section; and an output section which, when it is judged by the identifying section that the second display section is connected to the cabinet, stops the output of signals from the first display control section, and outputs signals to the second display from the second display control section.

An embodiment of the present invention will now be described with reference to accompanying drawings.

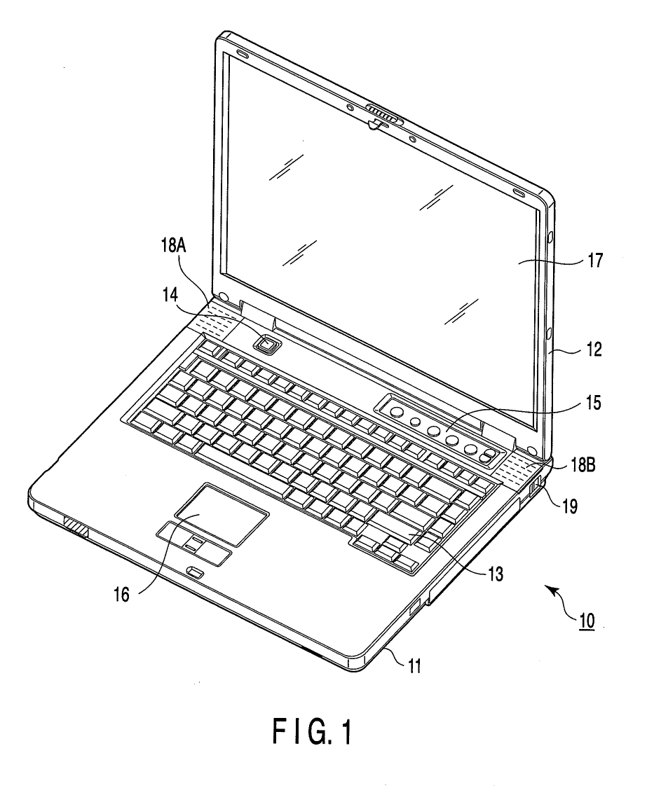

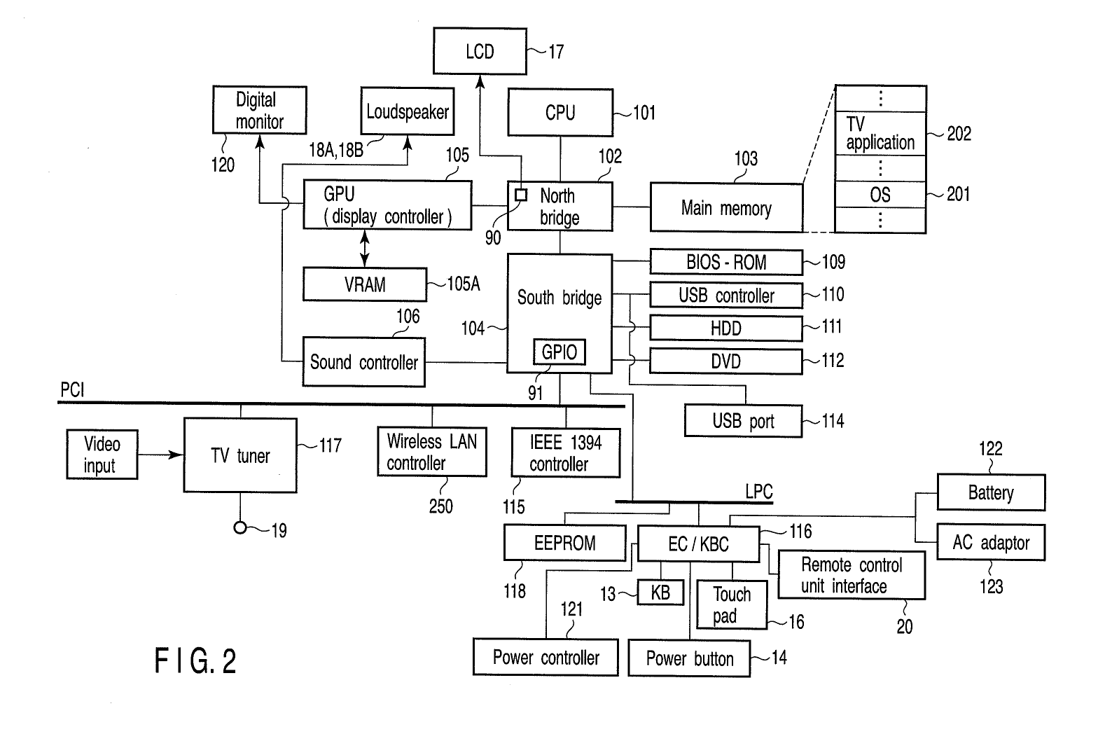

First, with reference to FIGS. 1 and 2, the structure of a data processing apparatus according to an embodiment of the present invention will be explained. The data processing apparatus is, for example, realized as a notebook personal computer 10.

FIG. 1 is a perspective diagram showing the notebook personal computer 10 while the display unit is open. This computer 10 includes a computer main body 11 and a display unit 12. The display unit 12 contains a built-in display device configured of a thin film transistor liquid crystal display (TFT-LCD) 17, and the display screen of the LCD 17 is located substantially at the center of the display unit 12.

The display unit 12 is mounted to be pivotable between an open position and a close position on the computer main body 11. The computer main body 11 includes a thin box-shaped cabinet, on an upper surface of which, a keyboard 13, a power button 14 which turns ON/OFF the computer 10, an operation panel 15, a touch pad 16, loudspeakers 18A and 18B, a DVD drive 112, etc. are arranged.

The operation panel 15 is an entry device comprising a plurality of buttons which respectively start various functions, and it is used to enter an event corresponding to a button pressed by the user.

Next, with reference to FIG. 2, the system configuration of the computer 10 will be described.

As shown in FIG. 2, the computer 10 of this embodiment includes a CPU 101, a north bridge 102, a graphic processing unit (GPU) 90 built in the north bridge 102, a main memory 103, a south bridge 104, a general purpose input/output (GPIO) 91 built in the south bridge 104, an external GPU 105 connected by PCI EXPRESS standard, etc., a video memory (VRAM) 105A, a sound controller 106, a BIOS-ROM 109, a USB controller 110, a hard disk drive (HDD) 111, a DVD drive 112, (a plurality of) USB ports (USB terminals) 114, an IEEE 1394 controller 115, an embedded controller/keyboard controller IC (EC/KBC) 116, an LCD 17, a digital monitor (digitally connected monitor) 120, EEPROM 118, etc.

The CPU 101 is a processor which controls the operation of the computer 10 and it executes an operating system (OS) 201 and various types of application programs, loaded to the main memory 103 from the hard disk drive (HDD) 111. Further, the CPU 101 executes Basic Input Output System (BIOS) stored in the BOIS-ROM 109. BIOS is a program for controlling the hardware.

The USB controller 110 controls each of the USB ports (USB connection terminals) 114. The USB ports 114 are controlled based on the process order (priority order) data set in the registry, or the like, in advance. When the USB controller 110 receives a request from a device connected to a USB port 114 which has a higher priority in processing order than that of the device connected to a USB port 114 through which data are received and transferred, the controller 110 stops the receiving and transferring of the data with the current device and gives priority to the request from the device connected to the USB port 114 of the higher processing priority order to start the receiving and transferring of data with the device connected to the USB port 114 of the higher processing priority order.

The north bridge 102 is a bridge device which connects between a local bus of the CPU 101 and the south bridge 104. The north bridge 102 also contains an integrated memory controller which controls the access of the main memory 103. Further, the north bridge 102 also has a function of executing communications with the GPU 105 via, for example, a serial bus of PCI Express.

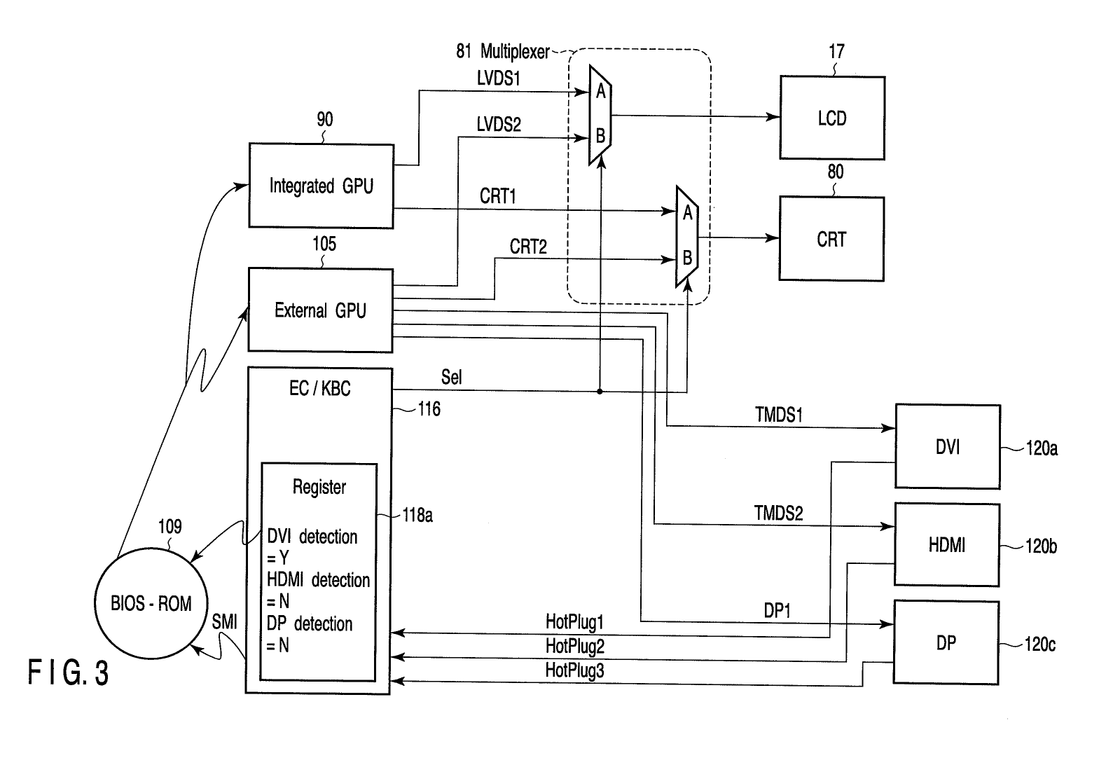

The GPU 90 built in the north bridge 102 is a display controller which controls the LCD 17 used as the display monitor of the computer 10, or a CRT 80 (see FIG. 3) which can be externally connected via an analog terminal such as miniD-sub or the like. The GPU 105 generates a display signal and sends it to the LCD 17.

On the other hand, the external GPU 105 is a display controller which controls the digital monitor 120 used as an externally connected by digital format of the computer 10. An external digital monitor 12 to be connected is usually or in many cases, of a type having a higher resolution than that of the usually employed LCD or the like. Therefore, the GPU 105 employed here is as well of a type having higher processing ability than that of the GPU 90 built in the north bridge 102 described above. The GPU 105 generates a display signal and sends it to the digital monitor 120.

The south bridge 104 controls each device on a low pin count (LPC) buss and each device on a peripheral component interconnect (PCI) buss. The south bridge 104 also contains a built-in integrated drive electronics (IDE) controller which controls the hard disk drive (HDD) 111 and DVD drive 112. Further, the south bridge 104 also has a function of executing communications with the sound controller 106.

The sound controller 106 is a sound source device, and outputs audio data to be produced to the loudspeakers 18A and 18B, etc.

The wireless LAN controller 250 is a wireless communication device which executes wireless communications of, for example, IEEE 802.11. The IEEE 1394 controller 115 executes communications with an external device via a serial bus of IEEE 1394.

The embedded controller/keyboard controller IC (EC/KBC) 116 is a one-chip microcomputer in which an embedded controller for managing the power and a keyboard controller for controlling the keyboard (KB) 13 and touch pad (16) are integrated. The embedded controller/keyboard controller IC (EC/KBC) 116 has a function of turning ON/OFF the power of the computer 10 in accordance with the user's manipulation of the power button 14. Further, the embedded controller/keyboard controller IC (EC/KBC) 116 executes the process of turning ON/OFF of the power of the computer 10 in accordance with the user's manipulation of the power button 14 in cooperation with the power controller 121 connected via a 12C bus. The power controller 121 supplies power to each component of the computer 10 using the power from a battery 122 built in the computer 10 or the power supplied from the outside via an AC adaptor 123.

Next, FIG. 3 is a conceptual diagram showing which GPU is connected to which respective monitor.

The structure which uses 2 GPUs as described above is called Hybrid GPU System. In the Hybrid GPU System, the integrated GPU 90 and the external GPU 105 are both mounted, and the GPUs are switched over depending on the use conditions. For example, when the computer 10 operates on the battery 122 as the power source, it is operated with the integrated GPU 90, whereas when the power is supplied from the AC adaptor 123 connected to the computer, it is operated with the integrated GPU 90.

The LCD 17 and CRT 80, which are display devices, are connected to each other via a multiplexer 81 so that they can display images under the control of both of the integrated GPU 90 and the external GPU 105. A DVI terminal 120a, an HDMI terminal 120b and a display port (DP) terminal 120c are connected only to the external GPU 105. In order to avoid the increase in both the cost and substrate area which results as the number of multiplexers 81 increases, the above-described connection is usually carried out.

LCD/CRT signals (LVDS1, 2, CRT1, 2) from the integrated GPU 90 and external GPU 105 are input to the multiplexers 81. The outputs of the multiplexers 81 are connected to the LCD 17 and CRT 80. DVI/HDMI/DP signals (TMDS1, 2, DP1) from the external GPU 105 are input to the DVI terminal 120a/HDMI terminal 120b/display port (DP) terminal 120c, which are directly connected thereto. Hot plug signals (HotPlug1, 2, 3) of the DVI terminal 120a/HDMI terminal 120b/display port (DP) terminal 120c are input to the EC/KBC 116 connected thereto.

When the integrated GPU 90 is operating, the BIOS-ROM 109 selects A for Sel (select) signal. (See the inside of the respective multiplexer 81.) When the external GPU 105 is operating and the LCD 17 or CRT 80 is used as a display, the BIOS-ROM 109 selects B for Sel (select) signal. (See the inside of the respective multiplexer 81.)

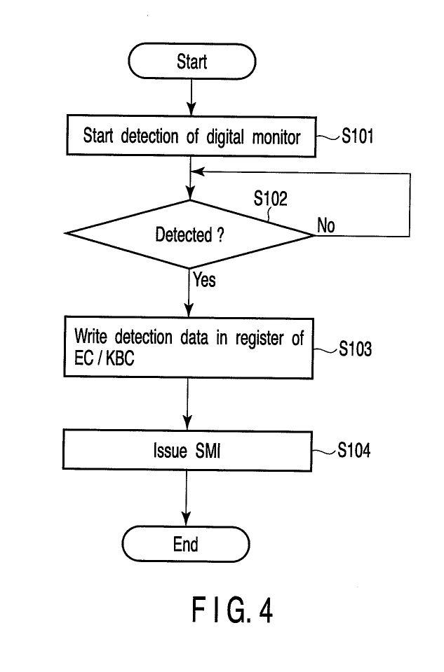

Next, a display control method to which the data processing apparatus according to the embodiment is applied will now be described with reference to the flowcharts shown in FIGS. 4 to 6.

An LCD signal (LVDS1) is output from the integrated GPU 90 of the computer 10. A is selected in the multiplexer 81. The LCD signal from the integrated GPU 90 is output to the LCD 17. From this condition, the EC/KBC 116 starts to detect the connection of the digital monitor 120 (block S101: FIG. 4).

When the EC/KBC 116 detects that the digital monitor 12 is connected, for example, a DVI-format digital monitor is connected (that is, a hot plug signal (HotPlug1) is detected (YES in block S102: FIG. 4), the EC/KBC 116 writes DVI detection data in the register (block S103: FIG. 4). Then, the EC/KBC 116 issues a system management interrupt (SMI) to the BIOS-ROM 109 (block S104: FIG. 4).

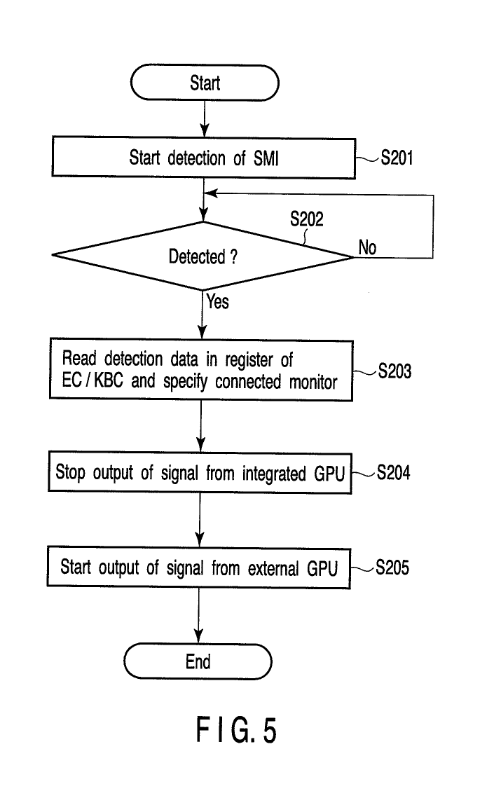

Next, a process executed by the BIOS-ROM 109 when SMI regarding the connection of a digital monitor is received will now be described with reference to FIG. 5.

The BIOS-ROM 109 starts the detection of SMI (block S201: FIG. 5). When the SMI is detected by the BIOS-ROM 109 (YES in block S202: FIG. 5), the issuance of the SMI is accepted and the register of the EC/KBC 116 is read, thereby specifying the display device detected, which is, in this case, for example DVI-format digital monitor (block S203: FIG. 5). The BIOS-ROM 109 then stops the output of signals to the LCD 17 of the integrated GPU 90 (block S204: FIG. 5). Subsequently, the BIOS-ROM 109 initializes the external GPU 105, and the output of signals to the DVI from the external GPU 105 is started (block S205: FIG. 5).

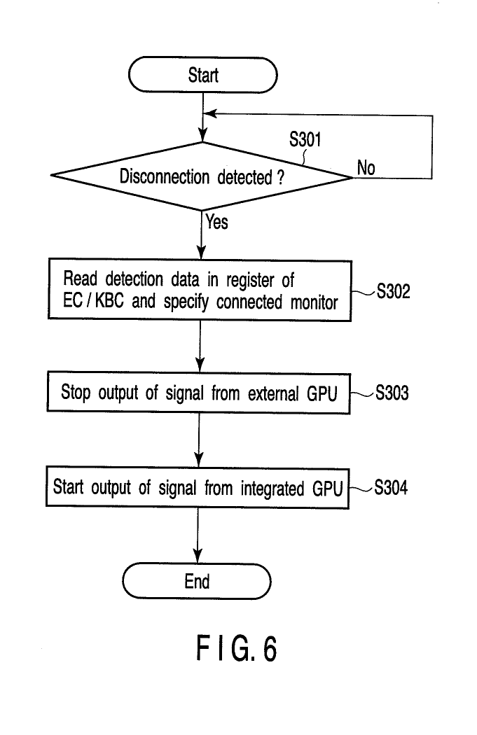

Next, a process executed by the BIOS-ROM 109 when SMI regarding the disconnection of a digital monitor is received will now be described with reference to FIG. 6.

When the SMI of the disconnection of the digital monitor is detected by the BIOS-ROM 109 (YES in block S301: FIG. 6), the issuance of the SMI is accepted and the register of the EC/KBC 116 is read, thereby specifying the display device detected that it has been disconnected, which is, in this case, for example DVI-format digital monitor (block S302: FIG. 6). The BIOS-ROM 109 then stops the output of signals to the DVI terminal 120a of the external GPU 105 (block S303: FIG. 6). Subsequently, the BIOS-ROM 109 initializes the internal GPU 90, and the output of signals to the DVI from the internal GPU 105 is started (block S304: FIG. 6).

It should be noted that the digital monitor 120 is of a type compatible with hot plug. In other words, the monitor 120 should be of a type which can be connected or disconnected (plug in or out) while the power of the computer 10 is on.

The above-described embodiment is described in connection with an example case where the BIOS-ROM 109 controls the switching of the displays; however the present invention is not limited to such a structure. That is, it may be a VIDEO-BIOS, an exclusive-use driver, or the like, which controls the switching. Further, in the above-described embodiment, the data of the digital monitor 120 detected (detected data) is stored in the register of the EC/KBC 116; however the invention is not limited to this, but the data may be stored in, for example, a flash memory.

The present invention has been proposed under such circumstances, and an object thereof is to provide a data processing apparatus and a display control method which can automatically switch to an appropriate GPU control without having to reboot the system when a high-resolution external monitor is connected to the apparatus.

According to the above-described embodiment, the switching control of GPUs can be carried out automatically and appropriately without rebooting the system in such cases where an external monitor of a higher resolution is connected, the supply of power is sufficient when an AC adaptor or the like is plugged, the power consumption should desirably be reduced such as when the battery is driven, etc.

It should be noted that the present invention is not limited to the above-described embodiment as it is, and when practicing the invention, it can be embodied while the structural elements are modified as long as the essence of the invention remains within the scope thereof. Further, various modified versions of the invention can be formed by combining some of the structural elements disclosed in the above embodiments as needed. For example, some of the structural elements may be deleted from the entire structure presented in the embodiment. Further, structural elements of difference embodiments may be combined as needed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a cabinet;
a first display connected to the cabinet;
a first display controller integrated in the cabinet, and configured to control the first display;
a second display controller integrated in the cabinet, and configured to control a second display configured to connect to the cabinet;
an identifying module configured to identify connection of the second display; and
an output module configured to stop the output of signals from the first display controller, and to output signals to the second display from the second display controller when the identifying module determines that the second display is connected to the cabinet.

2. The information processing apparatus of claim 1, wherein the output module is configured to stop the output of signals from the second display controller, and to output signals to the first display from the first display controller when the identifying module determines that the second display is disconnected from the cabinet.

3. The information processing apparatus of claim 1, wherein the first display controller is integrated in a chip set.

4. The information processing apparatus of claim 1, wherein the second display is connected to the cabinet by a digital format.

5. The information processing apparatus of claim 4, wherein the second display is configured to function in accordance with the connection and disconnection with the cabinet while the power of the cabinet is on.

6. A display control method to be executed in an information processing apparatus comprising a cabinet, a first display connected to the cabinet, a first display controller integrated in the cabinet and configured to control the first display, and a second display controller integrated in the cabinet and configured to control a second display configured to connect to the cabinet, the method comprising:
stopping the output of signals from the first display controller, and outputting signals to the second display from the second display controller when the connection between the second display and the cabinet is detected.

7. The display control method of claim 6, further comprising: stopping the output of signals from the second display controller, and outputting signals to the first display from the first display controller when it is detected that the second display section is disconnected from the cabinet.

8. The display control method of claim 6, wherein the first display controller is integrated in a chip set.

9. The display control method of claim 6, wherein the second display is connected to the cabinet by a digital format.

10. The display control method of claim 9, wherein the second display is configured to function in accordance with the connection and disconnection with the cabinet while the power of the cabinet is on.
